(19) United States
(12) Patent Application Publication
(10) Pub. No.: US 2009/0021132 A1
(43) Pub. Date: Jan. 22, 2009

(54) LAMP HAVING A BULB COMPRISING A BURNER AND A SHIELDING MEMBER

(75) Inventor: Bernardus Lambertus Martinus Van Bakel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 12/278,290

(22) PCT Filed: Jan. 31, 2007
(86) PCT No.: PCT/IB07/50321

§ 371 Date: Aug. 5, 2008

(30) Foreign Application Priority Data
Feb. 8, 2006 (EP) 06101408.0

(51) Int. Cl. H01K 1/58

(52) U.S. Cl. 313/42

(57) ABSTRACT

A lamp comprising a base part (2) for connecting the lamp to a lamp holder, a bulb (1) attached to said base part (2), which bulb (1) contains a burner (4) and a gas, and a shielding member (7) between the burner (4) and the base part (2). The shielding member (7) divides the space (3) inside the bulb (1) into two volumes (8, 9). One or more openings (10) connect said two volumes (8, 9), so that the convection flow (12) in one volume (8) interacts with the flow (13) in the other volume (9).

The invention relates to a lamp comprising a base part for connecting the lamp to a lampholder and a bulb attached to the base part, which bulb contains gas and a burner, and a shielding member between the burner and the base part, which shielding member divides the space inside the bulb into two volumes. The expression ‘volume’ is used to indicate a limited space.

Such a lamp is disclosed in U.S. Pat. No. 4,829,210, which publication describes a reflector lamp where the bulb (outer envelope) of the lamp comprises a parabolic reflecting surface and a neck portion. The neck portion of the bulb is attached to the base part of the lamp, which base part can be screwed into a lampholder. The burner of the lamp is mounted on the inside of the neck portion of the bulb by means of a multifunctional member in order to align the burner optically with respect to the reflecting surface of the bulb. The multifunctional member divides the space inside the bulb into two volumes, a first volume containing the burner and a second volume surrounded by the neck portion of the bulb. The multifunctional member thus reflects heat away from the base part of the lamp, while the member is a shielding member for blocking convective heat transfer by the gas in the bulb from the burner into the neck portion of the bulb of the lamp, i.e. from the first volume to the second volume inside the bulb.

In general, it is important to reduce heat transfer from the burner to the base part of the lamp, especially if the base part is provided with components that should not be exposed to high temperatures. When the lamp is operated in the base-up position, i.e. the position in which the base part is directed upward, the gas in the bulb will flow upward from the burner towards the base part of the lamp. Then the gas will flow outward towards the wall of the bulb and will flow downward along the wall of the bulb, with the result that the gas will cool down owing to heat being transferred to the material of the wall of the bulb. So, there is a convective heat transfer from the burner towards the base part of the lamp.

When the lamp is provided with a shielding member as disclosed in U.S. Pat. No. 4,829,210, there will be a gas flow from the burner to the shielding member and along the shielding member to the wall of the bulb, and then in downward direction along the wall of the bulb. The shielding member will be heated up thereby, resulting in a convective gas flow in the second volume, with the gas flowing from the shielding member directly towards the base part, and then outward to the outside wall of the lamp. So there will be a substantial heat transfer from the burner to the base part of the lamp, especially when the lamp is operated in the base-up position, in spite of the presence of the shielding member.

An object of the invention is a lamp comprising a base part and a bulb attached to the base part, the space inside the bulb containing a gas, while a shielding member is present inside the bulb in order to divide said space into a first volume containing the burner and a second volume near the base part, wherein heat transfer by convection from the burner to the base part is reduced.

To achieve this object, there are one or more openings present to connect the two volumes. Because of the openings, the convective gas flows in the two volumes will mutually interact, so that the gas will flow in the same direction on both sides of the shielding member. When the lamp is operated in the base-up position, the gas in the first volume will flow outward along the surface of the shielding member towards the wall of the bulb. The presence of said one or more openings will cause the gas in the second volume also to flow outward along the surface of the shielding member towards the outside wall of the lamp. Therefore, in the second volume, the gas will flow from the shielding member to the outside wall and then upward along that wall towards the base part of the lamp. The gas will thus be cooled by a heat transfer to the outside wall of the lamp. So, the heating-up of the base part is reduced by the presence of said one or more openings between the two volumes.

In a preferred embodiment, said one or more openings are located around the shielding member, for example between the shielding member and the wall of the bulb. Preferably, a substantial annular opening is present around the shielding member, i.e. located between the outer edge of the shielding member and the wall of the bulb. This does limit the dimension of the shielding member, but this dimension is still sufficient for guiding the convective gas flow in the first volume of the bulb to the wall of the bulb when the lamp is operating in the base-up position. At the other side of the shielding member, in the second volume, the gas flow will be driven by the gas flow in the first volume, so that the gas flow is also directed from the shielding member to the wall of the bulb, and subsequently the gas will flow upwardly towards the base part of the lamp.

The shielding member can be attached to the burner or to the connecting element between the base part and the burner. In a preferred embodiment, however, the shielding member is connected to the base part of the lamp. At least a portion of the shielding member is preferably electrically conductive in that case, such that electric current is supplied from the base part of the lamp through the shielding member to the burner of the lamp, so that the shielding member replaces at least one of the two current supply conductors.

In a preferred embodiment, the shielding member comprises an electrically conductive material, such that the shielding member comprises two mutually electrically insulated portions, each of said portions supplying electric current to the burner of the lamp, so that the shielding member replaces both current supply conductors of the burner.

Preferably, the burner is supported by the shielding member, enabling a simple structure inside the bulb of the lamp, with the shielding member serving as a heat reduction element and at the same time as a power supply element and as a support for the burner.

The invention will now be further elucidated by means of a description of two embodiments of a lamp comprising a base part and a bulb attached to the base part, wherein a shielding member is present inside the bulb in order to divide said space into two volumes, with reference to the drawing comprising three Figures, in which:

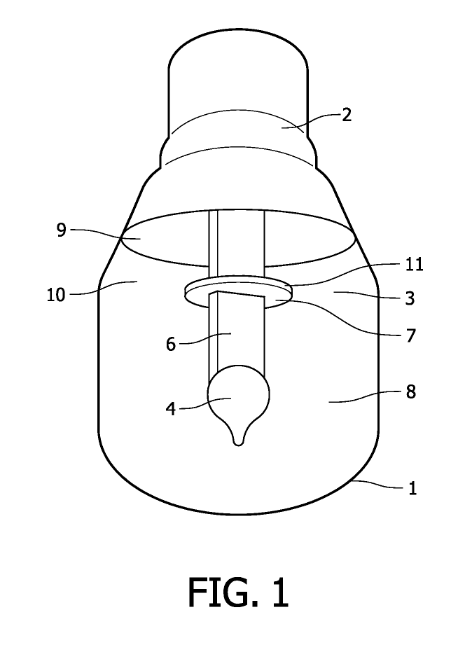

FIG. 1 is a perspective view of the first embodiment of the lamp,

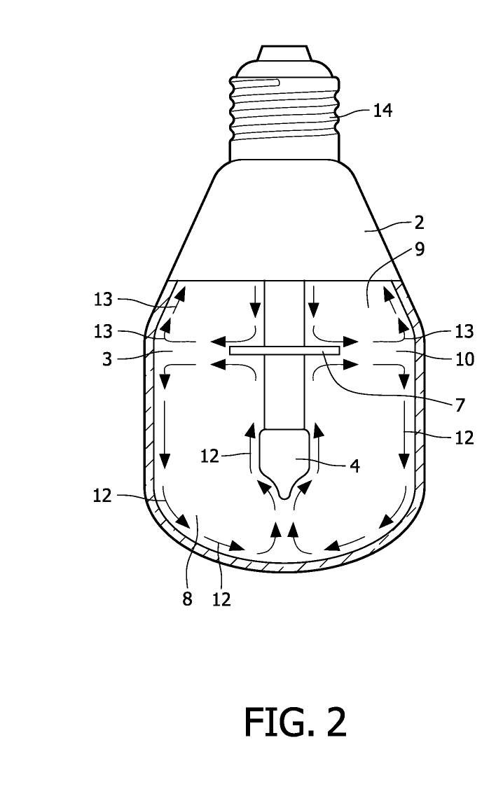

FIG. 2 shows the first embodiment partly in a sectional view; and

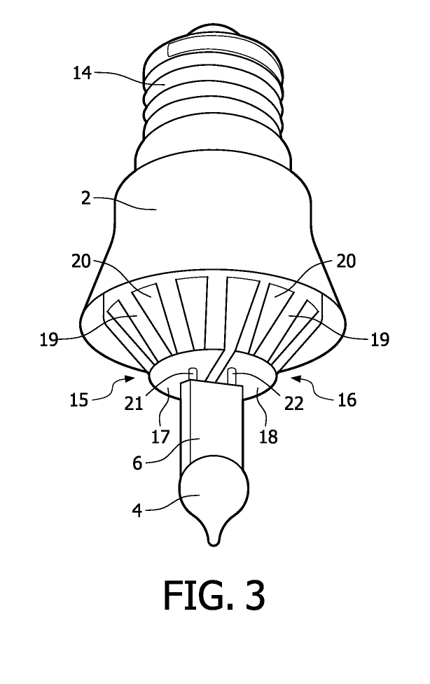

FIG. 3 is a perspective view of a second embodiment of the lamp.

The Figures are only schematic representations of the two embodiments of the lamp, wherein corresponding parts are indicated with the same reference numerals.

FIG. 1 shows a lamp comprising a bulb 1 of transparent glass, so that the parts inside the bulb 1 are visible. The bulb 1 is attached to a base part 2. The base part 2 is provided with means (not shown in FIG. 1) for connecting the lamp to a lamp holder such that power supply elements are interconnected in order to supply electric current to the lamp. The bulb 1 and the base part 2 enclose a space 3 that is filled with air, which space 3 contains a burner 4, for example a halogen burner. Lead wires to supply electric power to the burner 4 are embedded in a pinch 6, which pinch 6 is fixed in the base part 2 of the lamp. The base part 2 of the lamp contains electronic components such as, for example, an electronic driver for the burner 4.

A disk-type shielding member 7 is attached to the pinch 6 between the burner 4 and the base part 2. The shielding member 7 divides the space 3 inside the bulb 1 into a first volume 8 below the shielding member 7 and a second volume 9 above the shielding member 7. The first volume 8 and the second volume 9 are interconnected by an annular opening 10 which extends between the circular outer edge 11 of the shielding member 7 and the wall of the bulb 1.

The disk-type shielding member 7 may be made of metal or of glass and may be provided with a light-reflecting surface, so that it prevents radiation of heat from the burner 4 to the base part 2 in order to limit the temperature in the base part 2 of the lamp. The functioning of the electronic components in the base part 2 can be disturbed by too high temperatures, and furthermore the operational life of these components can be extended if the temperature is kept relatively low.

If the lamp is operated in the base-up position as shown in the Figures, the presence of the shielding member will substantially reduce the heat transfer from the burner 4 to the base part 2 through air convection. This will be further elucidated with reference to FIG. 2, which shows the air flows in the space 3 of the bulb 1 by means of arrows.

FIG. 2 shows the first embodiment of the lamp, the bulb 1 being shown in a sectional view. In the first volume 8 of the space 3 inside the bulb 1, there will be a convective air flow because of the high temperature of the burner 4. This air flow is indicated with arrows 12. The convective air flow 12 is directed upward along the hot outer surface of the burner 4 and is subsequently directed outward along the lower side of the shielding member 7. Then the air flow 12 is directed downward along the inner surface of the wall of the bulb 1 and returns to the outer surface of the burner 4. The air is heated up during its contact with the burner 4 and is cooled down during its passage along the wall of the bulb 1.

After the convective air flow 12 has passed the outer surface of the burner 4, whereby the air is heated up, it will pass along the lower side of the shielding member 7, and therefore, the disk-type shielding member 7 is heated up by the convective airflow 12 in the first volume 8. Because of the relatively high temperature of the shielding member 7, there will be also a convective air flow in the second volume 9 above the shielding member 7. This air flow is indicated with arrows 13.

If the second volume 9 were completely separated from the first volume 8, the convective airflow 13 in volume 9 would follow a path from the shielding member 7 upward to the central portion of the base part 2. The base part 2 would thus be heated by the air flow 13. The annular opening 10 between the first volume 8 and the second volume 9, however, causes the air flow 13 in the second volume 9 to follow another path. Near the opening 10, the convective air flow 12 in the first volume 8 will force the air in the second volume 9 to flow in the same outward direction. Therefore, the air in the second volume 8 will flow along the shielding member outward towards the wall of the bulb 1, and then turn in upward direction along the inner surface of the wall of the bulb 1. The air will accordingly cool down before it reaches the base part 2, so that the temperature of the base part 2 will be kept at a lower level.

In FIG. 2, the first embodiment of the lamp is provided with connection means 14 that can be screwed into a lamp holder.

FIG. 3 shows the second embodiment of a lamp, with the bulb of the lamp left out in order to show the parts inside the bulb more clearly. The bulb has the same shape as the bulb 1 in FIGS. 1 and 2. The base part 2 of the lamp is provided with connection means 14 that can be screwed into a lamp holder. The burner 4 of the lamp is connected to the base part 2 through a shielding member that comprises two portions 15, 16. Each portion 15, 16 of the shielding member comprise a semicircular disk 17, 18, and the two semicircular disks 17, 18 together form a circular disk. Furthermore, each portion 15, 16 comprises a number of legs 19 extending between each semicircular disk 17, 18 and the base part 2 of the lamp.

Openings 20 are present between the legs 19, so that the volume around the burner 4 (the first volume, at the lower side of the shielding member 15, 16) is connected to the volume above the shielding member 15, 16 (the second volume). Because of the openings 20, the convective air flow in the first volume (around the burner 4) will influence the air flow in the second volume (above the shielding member 15, 16), as was elucidated with reference to FIG. 2. Therefore, the airflow in the second volume that reaches the upper region of the base part 2 (adjacent the connection means 14) has passed along the inner surface of the outer wall of the base part 2 and will have been cooled down thereby.

The two portions 15, 16 of the shielding member are electrically insulated from each other, and each of the portions 15, 16 serves as a supply element for electric current to the burner 4. Therefore, each of the two lead wires 21, 22 enclosed in the pinch 6 of the burner 4 is connected to a respective portion 15, 16 of the shielding member. At least one leg 19 of each portion 15, 16 of the shielding member is electrically conductive or provided with a electrically conductive element in order to connect the lead wire 21, 22 to the relevant power supply member in the base part 2.

The two embodiments of the lamp as described above are only examples of a lamp according to the invention; many other embodiments are possible.

1. A lamp comprising a base part for connecting the lamp to a lampholder, a bulb attached to said base part, which bulb contains a burner and a gas, and a shielding member between the burner and the base part, which shielding member divides the space inside the bulb into two volumes, characterized by one or more openings connecting said two volumes.

2. A lamp as claimed in claim 1, characterized in that said one or more openings are located around the shielding member.

3. A lamp as claimed in claim 1, characterized in that a substantially annular opening is present around the shielding member.

4. A lamp as claimed in claim 1, characterized in that the shielding member is connected to the base part of the lamp.

5. A lamp as claimed in claim 4, characterized in that at least a portion of the shielding member is electrically conductive, electric current being supplied from the base part of the lamp to the burner through the shielding member.

6. A lamp as claimed in claim 5, characterized in that the shielding member comprises an electrically conductive material, such that the shielding member comprises two mutually electrically insulated portions, each of said portions supplying electric current to the burner of the lamp.

7. A lamp as claimed in claim 1, characterized in that the burner is supported by the shielding member.
